(19) United States
(12) Patent Application Publication
(10) Pub. No.: US 2002/0065936 A1
(43) Pub. Date: May 30, 2002

(54) Multi-platform application

(75) Inventor: Luigi Schiuma, Via Lucana (IT)

Correspondence Address: A. Bruce Clay, IBM Corp, IP Law Dept T81/503, 3039 Cornwallis Road, PO. Box 12195, Research Triangle Park, NC, 27709-2195, US

(73) Assignee: International Business Machines Corporation, Armonk, NY

(21) Appl. No.: 09/887,499

(22) Filed: Jun. 22, 2001

(30) Foreign Application Priority Data
Jul. 10, 2000 (GB) 0016700.7

(51) Int. Cl. G06F 15/173; G06F 15/16

(52) U.S. Cl. 709/238; 709/230

(57) ABSTRACT

An application operates on a computer adapted to communicate using at least an IPX/SPX protocol. The application includes a table for storing a plurality of IPX/SPX network segment addresses and the number of hops each segment is from the computer accessing the table. An IPX/SPX Routing Information Protocol (RIP) request packet sender transmits an RIP request packet across an IPX/SPX network; and an IPX/SPX Routing Information Protocol (RIP) response packet receiver receives RIP response packets from within a pre-determined number of network hops and stores the network segment addresses and the number of hops each segment is from the computer contained in said RIP response packets in the table. An IPX/SPX broadcaster is thus responsive to an application request to transmit an application defined packet to network segments within a pre-determined number of hops stored in the table.

### FIELD OF INVENTION

The present invention relates to a multi-platform application.

### Background of the Invention

The Internet has brought about an information revolution through the development of computerised information resources, on-line services and the World Wide Web (WWW). With enormous amounts of data on almost any topic imaginable available on the Internet, an ever increasing number of computers and users have been connected to the Internet.

Computers on the Internet address each other with a unique Internet protocol (IP) addresses. An IP address consists of four binary octets (usually represented in dotted-quad notation) with the value in each octet ranging from 0 to 255 decimal. These octets are broken down to provide an addressing scheme that can accommodate large and small networks. There are five different classes of networks, A to E. The class of an address is determined by the first octet of the address.

Class A: 1-126 (e.g. 10.1.23.19)

Class B: 128-191 (e.g. 172.16.19.48)

Class C: 192-223 (e.g. 193.18.9.10) etc.

In a class A address, the first octet is the network portion, so the class A example above has a major network address of 10. Octets 2, 3, and 4 (the next 24 bits) are for a network manager to divide into subnets and hosts as required. In the most common class B address, the first two octets are the network portion, so the class B example above has a major network address of 172.16. Octets 3 and 4 (16 bits) are for local subnets and hosts. Class B addresses are used for networks that have between 256 and 65,536 hosts.

Since it is generally easier to memorise words and phrases than it is to remember long sequences of numbers, domain name servers (DNS) perform the important task of converting a host name, such as for example “www.whowhere.com,” to an IP address, such as for example “1205.230.1.5.”

FIG. 1 is a block diagram that illustrates an Internet client 101 trying to connect to a web server 103 of an Internet Host ABC. As shown in FIG. 1, client 101 makes a DNS resolution request 107 to DNS server 105 to request the IP address of web server 103. DNS server 105 returns the IP address response 109 in reply to the DNS resolution request 107. After client 101 has received the IP address response 109 of web server 103, client 101 sends the hypertext transfer protocol (HTTP) request 111 to web server 103, which is addressed by IP address included in IP address response 109, and web server 103 therefore responds with an HTTP response 113 as shown in FIG. 1. Name resolution is described in detail in the Internet standards document Request for Comments (RFC) 1034.

Another function available with TCP/IP over the Internet is the ability to broadcast. A broadcast is a data packet destined for all hosts on a particular physical network. Network hosts recognise broadcasts by special addresses. For detailed discussions of broadcast issues in general, see RFC 919, “Broadcasting Internet Datagrams,” and RFC 922, “Broadcasting Internet Datagrams in the Presence of Subnets.”

The current standard for an Internet broadcast address requires that the host portion of the address consist of all binary “1”s. If the network portion of the broadcast address is also all “1”s, the broadcast applies to the local network only. If the network portion of the broadcast address is not all “1”s, the broadcast applies to the network or subnet specified.

There are in general two kinds of broadcasting: directed broadcasting and flooding. A directed broadcast is a packet sent to a specific network or series of networks, while a flooded broadcast packet is sent to every network. A directed-broadcast address includes the network or subnet fields. For example, if the network address is 128.1.0.0, then the address 128.1.255.255 indicates all hosts on network 128.1.0.0. This would be a directed broadcast. If network 128.1.0.0 has a subnet mask of 255.255.255.0 (the third octet is the subnet field), then the address 128.1.5.255 specifies all hosts on subnet 5 of network 128.1.0.0, another directed broadcast.

The IPX/SPX network protocol, on the other hand was developed by NOVELL for its PC-based file server product called “Netware”. One or more network interface cards can be installed in a Netware server, which is often done to improve network performance. For each network-card with its attached network-cable, a NET-number is assigned on the Netware server (in addition, each Netware server requires an internal NET-number for itself). These NET-numbers must be UNIQUE on the complete network. The complete Network-address of any system using IPX/SPX protocol is the combination of NET-number and MAC-address (which is unique world-wide) of the system's network interface card (NIC).

NetWare servers broadcast Service Advertising Protocol (SAP) packets every 60 seconds to make sure that routers know about their services, and routers seeing these packets build a SAP table with an entry for each service advertised by each known server. When a router stops receiving SAP broadcasts from a server, it ages that entry in its SAP table and eventually removes it from the table. SAP request/responses are then used for the following:

a client request for the name and address of the nearest type of server required;

a general request by a router for names and addresses of all servers;

a response to a nearest server request or general request;

60 second periodic broadcasts; or

a broadcast of changed server information.

Each service type is allocated a service number by Novell, and the complete list of Novell SAP Numbers can be found, among other places, at: http://www.isi.edu/in-notes/iana/assignments/novell-sap-numbe rs. Clients determine if required services are available by sending SAP requests on Port 452h, and on finding the required service is available, the client can then send a Routing Information Protocol (RIP) request on Port 453h to find a route to the server.

Thus, if a new IPX/SPX service is to be set-up, rather than the relatively free manner in which web sites can obtain domain names and subsequently be located via a DNS, the service provider must first ensure that their service is allocated a SAP service number and also that clients know the service number to look for, for example, Tektronix uses Service Number 0535.

Furthermore, it should be seen that while TCP/IP client/server applications can be customized by the user in order to use a specific sockets pair compatible with the users needs, IPX/SPX servers (providing a specific service) have to use a pre-determined port in order to be addressable via SAP.

This reduces the flexibility of IPX/SPX client/server applications compared with the TCP/IP ones.

It will be seen therefore that IPX/SPX doesn't provide a native naming request (NR) system analogous to the TCP/IP based DNS, so making porting of TCP/IP to IPX/SPX based applications difficult. Also IPX only allows a client to broadcast within a subnet and so porting TCP/IP applications relying on an IPX/SPX broadcast mechanism is also difficult.

Thus, while many Netware servers exist and many clients are capable of communicating using either TCP/IP or IPX/SPX client/server, applications in general need to be written for one platform or the other.

### DISCLOSURE OF THE INVENTION

Thus, the present invention provides an application operable on a computer adapted to communicate using at least an IPX/SPX protocol, said application comprising: means for accessing a table for storing a plurality of IPX/SPX network segment addresses and the number of hops each segment is from the computer accessing said table; IPX/SPX Routing Information Protocol (RIP) request packet sending means adapted to transmit an RIP request packet across an IPX/SPX network; IPX/SPX Routing Information Protocol (RIP) response packet receiving means adapted to receive RIP response packets from within a pre-determined number of network hops and to store the network segment addresses and the number of hops each segment is from the computer contained in said RIP response packets in said table; IPX/SPX broadcast means responsive to an application request to transmit an application defined packet to network segments within a pre-determined number of hops stored in said table.

### BRIEF DESCRIPTION OF THE DRAWINGS

Embodiments of the invention will now be described with reference to the accompanying drawings, in which:

FIG. 1 illustrates a prior art web client connecting to a web server;

FIG. 2 illustrates a network including multi-platform applications according to the present invention and

FIG. 3 illustrates a multi-platform application according to the invention.

### DESCRIPTION OF THE PREFERRED EMBODIMENTS

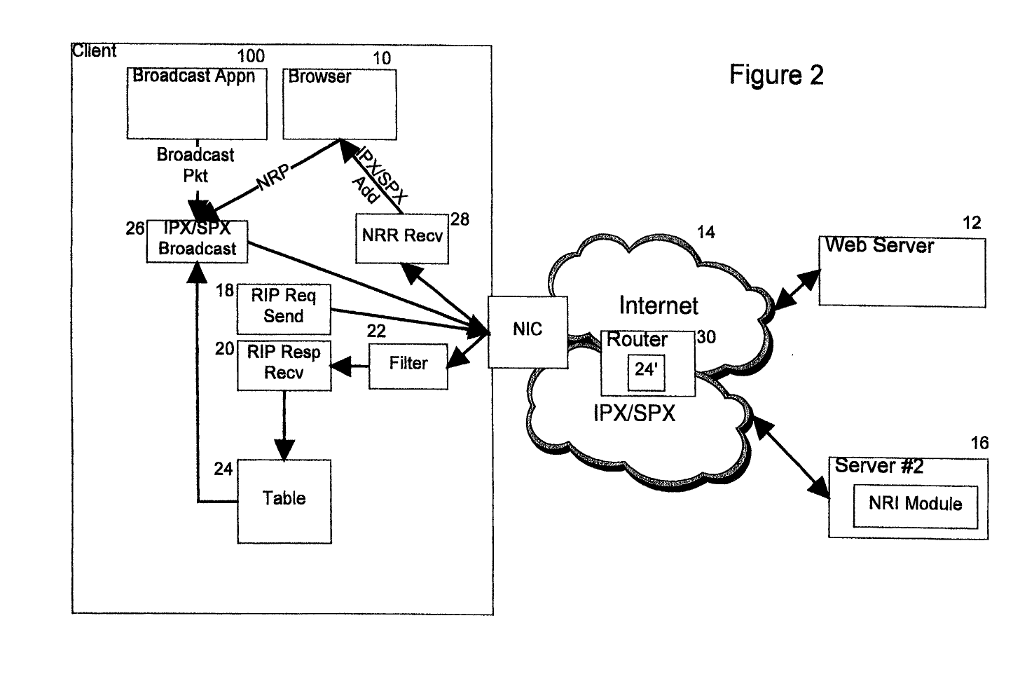

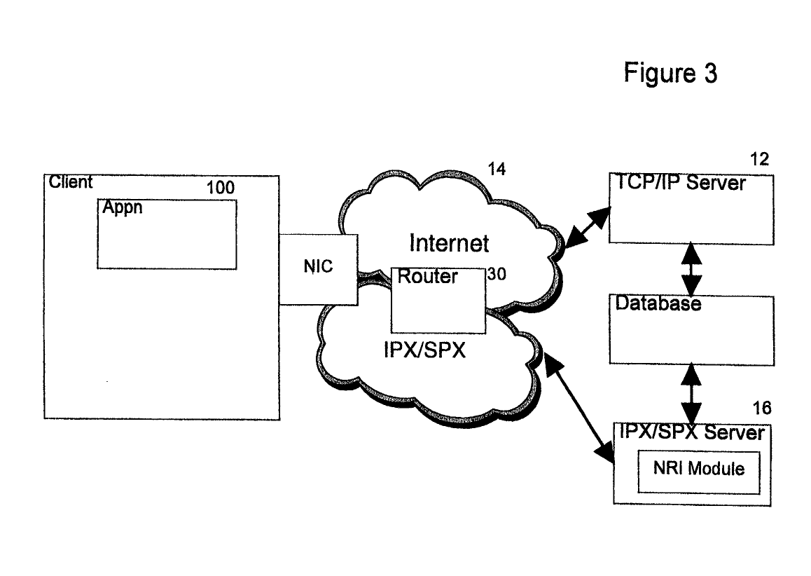

Referring now to FIG. 2, a preferred embodiment of the invention is described in terms of an Internet web browser 10 and later, in relation to FIG. 3, an application 100 requiring broadcast capability, although it will be seen that the invention is applicable to any multi-platform application.

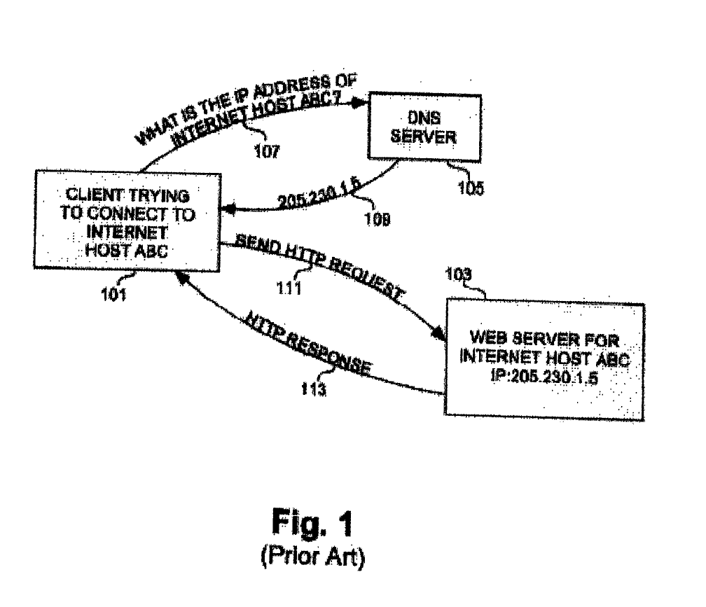

A conventional browser 10 and the application 100 run on a client machine equipped to operate using both TCP/IP and IPX/SPX protocols described above. The browser connects to any number of web servers (only one 12 shown) across the Internet 14 and, as explained in relation to FIG. 1, the browser issues DNS requests, whenever the client browser needs to connect to a new server. (It is acknowledged that some browsers cache DNS responses and do not make a DNS request every time they connect to a web site.)

Using the convention Novell SAP based approach, IPX/SPX name resolution would require the browser to translate the web page address to a SAP service number, thus the browser would need to have a translation table available for converting web-type URLs to SAP service numbers, and for the server to have obtained a SAP service number and to be broadcasting the availability of its service across the IPX/SPX network.

The present embodiment, however, employs the IPX/SPX RIP (Routing Information Protocol) which is used for the exchange of routing information. (It is not identical to the RIP implementation of TCP/IP—Novell has added an extra field, which is called ‘Number of Ticks’ to the official XNS-protocol.) RIP uses IPX for addressing purposes with the Data part of an IPX-packet containing RIP being as follows:

| Operation | | NetID | | NrHops | | NrTick | |
|---|---|---|---|---|---|---|---|
| 2 | bytes | 4 | bytes | 2 | bytes | 2 | bytes |

Operation (Indicates a request or response): A 1 in this field is a request and a 2 is a response. A request contains only the NetID, the other fields are nulled out. The response can be a periodic broadcast or a reply to a request.

NetID (Network Number): Indicates the network segment to which the packet will be sent.

NrHops (Number of Hops): The amount of routers needed to reach the destination.

NrTicks (Number of Ticks): The amount of time needed to reach the destination segment (there are 18.21 ticks in a second and the number in the field is at least 1)

The part after the Operation-field, can be repeated several times (max. 50), to contain the information of several network-segments.

The client includes a (Routing Information Protocol) RIP request sender 18 which is used to send a IPX/SPX RIP packet to all the IPX subnets connected N hops from itself. Since such RIP requests/responses are routed across routers, as a response to a RIP request packet being sent, a set of RIP responses is received by the client issuing the RIP request. As explained above, each response contains the IPX NetNumber and the number of hops that separate the requester from each specific subnet. Within the client, the set of responses is received by a RIP responses collector 20; which operates in conjunction with a RIP responses filter 22 to allow the network scope to be limited to the pre-determined number of hops. Thus, after filtering the responses, a set of M Network Numbers that satisfy the hops criteria. (eg. 1200aa, 239033,009800, . . .) is available to the client. In the preferred embodiment, the numbers are stored in a table 24 either in storage or in memory.

The client can then send any IPX/SPX packet to the M addresses (eg. 1200aa.000000000000, 239033.000000000000, 00980.000000000000, . . .) stored in the table 24. In the preferred embodiment, an IPX/SPX broadcast module 26 is supplied so that the application can simply supply the module 26 with the packet it wishes to broadcast and preferably the number of hops P across which it wishes to broadcast the packet, so performing a specific broadcast in the selected subnets.

It should be seen that if the number of hops P exceeds the number of hops N with which the table 24 was originally built, then the module 26 can either prompt the RIP request sender module 18 to send another RIP request, with the responses being filtered to subnets within P hops; or the broadcast can be made simply to the subnet addresses available at the time with a return code issued to the application that it should update the table 24; or no broadcast may be made with a suitable return code being issued to the application 10, 100.

In any case, the application 10, 100 which requires broadcast over either TCP/IP or IPX can use either the TCP/IP broadcast system explained in the introduction or similarly, the application can broadcast a packet within a pre-determined number of hops to any of the subnets listed in the table 24.

Turning now to the browser 10 and the problem of IPX/SPX name resolution, in a first embodiment of the invention, the browser responds to a DNS response indicating a failure to locate a TCP/IP address for a web server, by attempting to locate a corresponding server located on an IPX/SPX network—in this case server 16.

The client thus needs to retrieve the IPX/SPX address of the server 16 which supplies a service corresponding to the URL supplied by the user. In the preferred embodiment, the browser either responds directly to a DNS failure to find a TCP/IP server for such a URL to begin the search for the server; or the browser or the RIP request module itself periodically causes the RIP request module to send out an RIP request across the IPX/SPX network with the table 24 being built as before.

The client then uses the IPX/SPX extended broadcast mechanism module 26 to send an IPX packet (Name Request Packet (NRP)) containing an opportune eye_catcher including the name of the server it is looking for to every IPX/SPX subnet within Q hops and starts waiting for an answer.

The server 16 which is making its services available in co-operation with the multi-platform browser of the invention includes a Name Requests Interceptor (NRI) module 24. The NRI module runs as a daemon that listens for incoming NRPs; so that when a NRP containing the name of the server is detected, a Name Request Response packet (NRR) is sent back to the requester client.

The client includes a naming request response listener 28 which wakes up and extracts the IPX/SPX address of the NRR sender from the packet. This is supplied to the browser which can then make the connection to the server 16, possibly even communicating with the server 16 using HTML/HTTP to produce and display web pages in a manner transparent to the end-user.

It should be seen that while the preferred embodiment has been described in terms of client applications operating over both TCP/IP and IPX/SPX, the invention is equally implementable in IPX/SPX servers for server type applications or can even be implemented in routers.

Take, for example, the router 30. The router can be adapted to listen for DNS response packets indicating a failure to find a TCP/IP address for a URL. As in the client embodiment, the router may either periodically build its own table 24′ of IPX/SPX subnet addresses or it may refresh the table 24′ only in response to such a DNS failure response. In any case, the router then carries out an extended broadcast sending a NRP packet across R hops. If an NRR is received, this is relayed to the client which includes an adapted NRR receiving module which extracts the server's IPX/SPX address so enabling the client to communicate directly with the server.

An example of an application 100 that makes use of the IPX/SPX and TCP/IP broadcast and name resolution described above, allows many clients to be managed by a pool of interconnected TCP/IP and IPX/SPX servers sharing, for example, a common database, FIG. 3.

A client, such as the client described in FIG. 2, can be enrolled in the infrastructure after an handshake (login) with any one of the servers. The initial phase of the login is based on one of a TCP or IPX datagram packet (broadcast or for a specific server if the address is known) sent by the client using a connectionless protocol. This packet is presumably received by a respective one of the TCP/IP or IPX/SPX Servers according to the type of packet sent. (If no reply is received by client within a timeout, the other of the TCP/IP or IPX/SPX protocol is tried.) In any case, the initial packet contains the information needed by the server to contact the client, for example, the client TCP/IP or IPX/SPX address and the port to which the client is listening. Now, the server using a connection oriented protocol (as distinct from the connectionless protocol of the initial packet) concludes the handshake with the client.

The client, comprising a daemon which starts at the machine boot, can send its initial packet in three different ways:

it can broadcast the packet using a default port (using either conventional TCP/IP broadcast or IPX/SPX broadcast described above);

it can broadcast the packet using a user-specified port; or

it can send the packet to a specific server specifying its name, using either TCP/IP naming resolution or IPX/SPX naming resolution described above (and possibly the port if it is different from the default).

It will be seen that, in this example, as distinct from conventional SAP based techniques, by appropriately tuning the ports to which the servers listen, it is then possible to determine which servers manage the clients belonging to specific classes. For example, if an organisation includes servers and clients physically located in Italy and Spain, then the Italian servers and clients can be set to operate on one port and the Spanish servers and clients to operate on another. If all Spanish TCP/IP and IPX/SPX servers fail, then it would be possible for a Spanish client user to reconfigure their ports to the Italian ports and to connect to the Italian servers providing the required service. Similarly, if one of the group of Spanish or Italian servers were found to be consistently busier than the other, then a simple tuning of the server ports could balance server load—something which would be impossible to do using conventional SAP based techniques.

The invention thus allows applications to provide the same functionality both using TCP/IP and IPX/SPX without significantly changing the design of the code.

What is claimed is:

1. An application operable on a computer adapted to communicate using at least an IPX/SPX protocol, said application comprising:
means for accessing a table for storing a plurality of IPX/SPX network segment addresses and the number of hops each segment is from the computer accessing said table;
IPX/SPX Routing Information Protocol (RIP) request packet sending means adapted to transmit an RIP request packet across an IPX/SPX network;
IPX/SPX Routing Information Protocol (RIP) response packet receiving means adapted to receive RIP response packets from within a pre-determined number of network hops and to store the network segment addresses and the number of hops each segment is from the computer contained in said RIP response packets in said table;
IPX/SPX broadcast means responsive to an application request to transmit an application defined packet to network segments within a pre-determined number of hops stored in said table.

2. An application according to claim 1 wherein said application is a multi-platform Internet browser adapted to communicate using a TCP/IP protocol and further comprising:
means, responsive to a domain name server (DNS) response indicating failure to locate a web server corresponding to a uniform resource locator (URL), for causing said IPX/SPX broadcast means to transmit a name request for an IPX/SPX server providing a service corresponding to said URL; and
means, responsive to receipt of a response to said name request containing an IPX/SPX address of an IPX/SPX server, for relaying said address to said application enabling peer-to-peer communication between said application and said IPX/SPX server.

3. An application according to claim 2 wherein said IPX/SPX Routing Information Protocol (RIP) request packet sending means is responsive to a domain name server (DNS) response indicating failure to locate a web server corresponding to a uniform resource locator (URL), to transmit said RIP request packet across an IPX/SPX network.

4. An application according to claim 2 wherein said IPX/SPX Routing Information Protocol (RIP) request packet sending means is adapted to periodically transmit said RIP request packet across an IPX/SPX network.

5. An application according to claim 1 comprising:
means for causing said IPX/SPX broadcast means to transmit a name request for an IPX/SPX server providing a service; and
means, responsive to receipt of a response to said name request containing an IPX/SPX address of an IPX/SPX server, for relaying said address to said application enabling connection oriented peer-to-peer communication between said application and said IPX/SPX server.

6. An application as claimed in claim 5 wherein said application is adapted to communicate using a TCP/IP protocol and further comprising:
means, responsive to no reply being received for said name request, for transmitting a TCP/IP name request for a TCP/IP server providing said service.

7. An application as claimed in claim 1 wherein said computer is a multi-platform router also adapted to communicate using a TCP/IP protocol, said router comprising:
means, responsive to a domain name server (DNS) response for a client indicating failure to locate a web server corresponding to a uniform resource locator (URL) required at said client, for causing said IPX/SPX broadcast means to transmit a name request for an IPX/SPX server providing a service corresponding to said URL; and
means, responsive to receipt of a response to said name request containing an IPX/SPX address of an IPX/SPX server, for relaying said address to said client enabling peer-to-peer communication between said client and said IPX/SPX server.

8. An application as claimed in claim 1 wherein said computer is a multi-platform router also adapted to communicate using a TCP/IP protocol, said router comprising:
means, responsive to a domain name server (DNS) request from a client, for causing said IPX/SPX broadcast means to transmit a name request for an IPX/SPX server providing a service corresponding to said URL; and
means, responsive to receipt of a response to said name request containing an IPX/SPX address of an IPX/SPX server, for relaying said address to said client enabling peer-to-peer communication between said client and said IPX/SPX server.

9. A multi-platform application as claimed in claim 1 wherein said computer is a server.

10. A computer program product comprising computer program code stored on a computer readable storage medium for, when executed on a computing device, communicating using at least an IPX/SPX protocol, the program code comprising the application of claim 1.

11. In a computer connected to a network, a method for communicating using at least an IPX/SPX protocol, comprising the steps of:
transmitting a Routing Information Protocol (RIP) request packet across an IPX/SPX network;
receiving one or more RIP response packets from within a pre-determined number of network hops;
storing in a table a plurality of IPX/SPX network segment addresses and the number of hops each segment is from the computer accessing said table contained in said RIP response packets; and
responsive to an application request, transmitting an application defined packet to network segments within a pre-determined number of hops stored in said table.
